(19) United States
(12) Patent Application Publication
(10) Pub. No.: US 2024/0203312 A1
(43) Pub. Date: Jun. 20, 2024

(54) SYSTEM AND METHOD FOR MODIFYING DISPLAY CONTENT TO OBSCURE SCREEN CAPTURE

(71) Applicant: Snap Inc., Santa Monica, CA (US)

(72) Inventor: William David Nuckols, Seattle, WA (US)

(21) Appl. No.: 18/069,021

(22) Filed: Dec. 20, 2022

(51) Int. Cl. G09G 3/20; G06F 21/84

(52) U.S. Cl. CPC G09G 3/2003; G06F 21/84; G09G 2320/0626; G09G 2340/0435; G09G 2358/00; G09G 2360/144

(57) ABSTRACT

A system and method for obscuring content from screen capture by a user device comprises accessing a content item. The system and method further comprise generating modified content item comprising a set of frames based on the content item, the set of frames comprising: a first frame comprising a modified version of the content item, and a second frame comprising a solid color. The system and method further comprise causing display of the modified content item by the user device. The causing of the display comprises causing the user device to alternate between displaying the first frame and the second frame.

### TECHNICAL FIELD

The present disclosure generally relates to modifying content for display. In particular, example embodiments of the present disclosure address systems, methods, and user interfaces for obscuring content from screen capture.

### BACKGROUND

Ephemeral content and ephemeral messages have become increasingly popular in recent years. However, screen capture on devices can capture ephemeral content, turning ephemeral content into a permanent image. For various reasons, including but not limited to security, privacy, and the right to be forgotten, a user of an application may not want their content to be capable of being captured by a screen capture.

Many operating systems give the power to software developers to be able to mark elements within a user interface (UI) as sensitive such that if a user takes a screen capture of the UI, the sensitive regions are subsequently wiped of data. Such use cases are popular in password management, banking applications, and other applications involving sensitive user data. However, in these conventional methods of handling sensitive data, the data is wiped by the operating system after screen capture. Nothing prohibits another device from taking an image of the screen of the device with the sensitive content and capturing the sensitive content, turning an ephemerally displayed UI into a permanent image. A more sophisticated methodology is needed to protect displayed content from screen capture on devices.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality.

FIG. 3 is a diagrammatic representation of a data structure as maintained in a database, according to some examples.

FIG. 4 is a diagrammatic representation of a message, according to some examples.

FIG. 5 is a flowchart for an access-limiting process, according to some examples.

FIG. 6 is a block diagram of the obscuration system, according to some examples.

FIG. 7 is a flowchart for a method of obscuring content from screen capture by a user device, according to some examples.

FIG. 8 is a flowchart for a method of obscuring content from screen capture by a user device, according to some examples.

FIG. 9 is a flowchart for a method of obscuring content from screen capture by a user device, according to some examples.

FIG. 10 is a flowchart for a method of obscuring content from screen capture by a user device, according to some examples.

FIG. 11A illustrates an example content item, according to some examples.

FIG. 11B illustrates an example first frame being displayed on a user device, according to some examples.

FIG. 11C illustrates an example second frame being displayed on the user device, according to some examples.

FIG. 12A illustrates an example first frame displayed on a user device, according to some examples.

FIG. 12B illustrates an example second frame displayed on a user device, according to some examples.

FIG. 12C illustrates an example third frame displayed on a user device, according to some examples.

FIG. 13A illustrates a set of pixels and subpixels, according to some examples.

FIG. 13B illustrates an example first frame at the pixel-level, according to some examples.

FIG. 13C illustrates an example second frame at the pixel-level, according to some examples.

FIG. 13D illustrates an example third frame at the pixel-level, according to some examples.

FIG. 14 is a diagrammatic representation of a machine in the form of a computer system within which a set of instructions may be executed to cause the machine to perform any one or more of the methodologies discussed herein, according to some examples.

FIG. 15 is a block diagram showing a software architecture within which examples may be implemented.

### DETAILED DESCRIPTION

The description that follows relates to systems and methods for modifying display content to obscure screen capture. When displaying an image, instead of displaying a static image, the systems and methods modify the image content to generate a dynamic display to obscure the image content from screen capture. The dynamic display includes a set of frames generated based on the image content, which dynamically rotates through the set of frames with each screen refresh. Thus the content appears as a static image to the human eye because the frames are flashing so rapidly. However, if a user takes a screen capture on a user device, the screen capture will only contain one of the frames. The captured frame will contain some form of modified content and therefore appear differently than the illusion of a static image to the human eye. As a result, the screen capture has been obfuscated without degrading the user's visual experience.

Content is modified and dynamically displayed as a set of frames such that the content is only partially displayed or only displayed part of the time, thus making screen capture difficult. According to some embodiments, content data comprising a content item is accessed, where the content item includes a set of pixels. The content item is modified to generate a set of frames, where the set of frames includes at least a first frame and a second frame.

The set of frames is provided for display on a user device. The user device is caused to alternate between displaying the first frame and the second frame. The user device alternates between displaying the first frame and the second frame at a rapid rate, such as based on the display refresh rate of the user device, which is faster than the user can perceive. That is, if the content item is a static image, the displayed set of frames will appear as the static image to the human eye rather than a dynamically displayed set of frames. By presenting content in this manner, it appears normal to the human eye, but if the user takes a screen capture of the content item, the screen capture contains the modified content item that is wholly or partially obscured.

For some embodiments, the first frame contains a modified version of the content item and the second frame is a solid color. For example, the first frame may include the content item modified to have an increased brightness and the second frame is a solid black frame. The set of frames is provided for display on a user device. The user device is caused to alternate between displaying the first frame and the second frame. According to some embodiments, the set of frames includes a third frame that is also the solid color. Consistent with these embodiments, the user device is caused to rotate between the first frame, the second frame, and the third frame. That is, the modified content item is displayed one third of the time, while the solid frames are displayed two thirds of the time. As a result, the user has a higher chance of screen capturing the solid color that does not contain the content item, thus obscuring the content item.

For some embodiments, the first frame includes a first subset of pixels from the content item but excludes a second subset of pixels while the second frame includes the second subset of pixels from the content item but excludes the first subset of pixels. Consistent with these embodiments, the set of frames may include additional frames, each including a subset of the pixels of the content item. The subsets of pixels may be randomly generated. The subsets of pixels may contain a predetermined amount of pixels from the content item. Similarly, if each frame contains a predetermined amount of pixels, the predetermined amount of pixels may be the same for each frame. For example, if there are three frames in the set of frames, then each frame contains one third of the total number of pixels in the content item. In these embodiments, if the user takes a screen capture, the user will capture a subset of the pixels, not the whole content item, thus obscuring the content item.

For some embodiments, the pixels of the content item are further subdivided into subpixel values. For example, the color and intensity of each pixel in the content item can be represented as a pixel vector that includes multiple subpixel values, where each subpixel value is associated with a particular subpixel color. For example, each pixel in a display may contain a red subpixel, a green subpixel, and a blue subpixel. Each pixel receives a pixel vector indicating how the pixel should illuminate. Similarly, the pixel vector can be further subdivided into subpixel values, each subpixel value associated with a subpixel. Accordingly, modifying the content item to generate a set of frames can include generating frames based on subsets of subpixel values from the content item. For example, a first frame has a first subset of subpixel values selected from the content item. Similarly, a second frame has a second subset of subpixel values, and a third frame has a third subset of subpixel values. In these embodiments, if the user takes a screen capture, the user will capture a subset of the subpixels, not the whole content item, thus obscuring the content item.

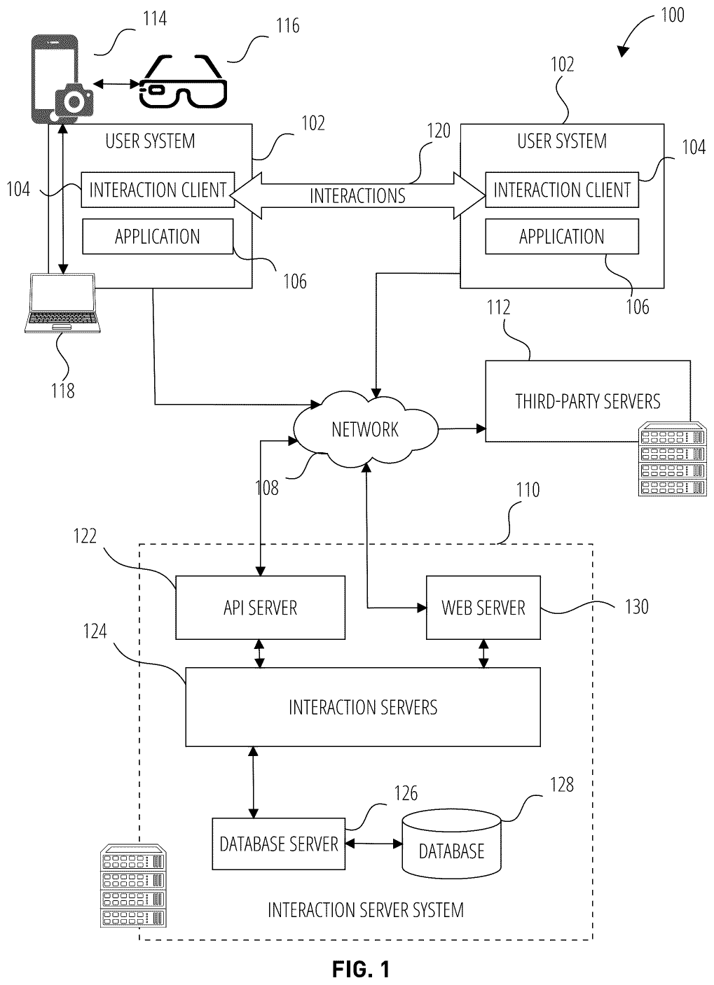

FIG. 1 is a block diagram showing an example interaction system 100 for facilitating interactions (e.g., exchanging text messages, conducting text audio and video calls, or playing games) over a network. The interaction system 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the client systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

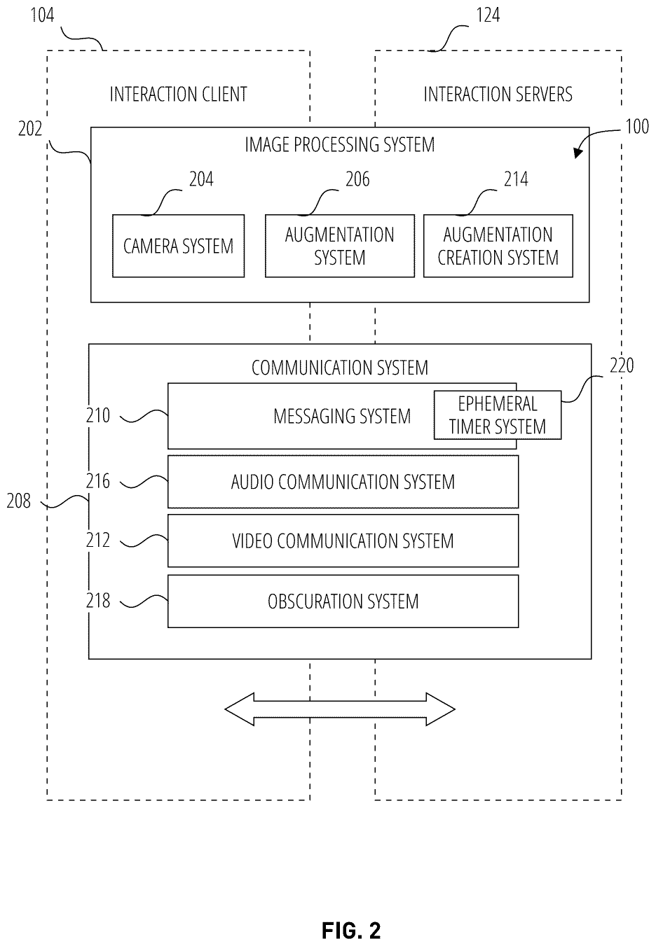

The interaction servers 124 host multiple systems and subsystems, described below with reference to FIG. 2.

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, a video communication system 212, and an obscuration system 218. The messaging system 210 is responsible for enforcing the temporary or time-limited access to content by the interaction clients 104. The messaging system 210 incorporates multiple timers (e.g., within an ephemeral timer system 220) that, based on duration and display parameters associated with a message or collection of messages (e.g., a story), selectively enable access (e.g., for presentation and display) to messages and associated content via the interaction client 104. Further details regarding the operation of the ephemeral timer system 220 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

In some embodiments, the communication system 208 also includes an obscuration system 218. The obscuration system 218 modifies visual content to obfuscate potential screen capture by obscuring content that is subject to the potential screen capture. The obscuration system 218 accesses content data that includes at least a content item that has visual content. The content data, including the content item, may have been generated or modified by the camera system 204, the augmentation systems 206, and/or the augmentation creation system 214. The obscuration system 218 generates a modified content item based on the content item where the presentation of the modified content item obscures the content item to obfuscate screen capture. The modified content item may be provided to the interaction clients 104 by the messaging system 210 within the communication system 208.

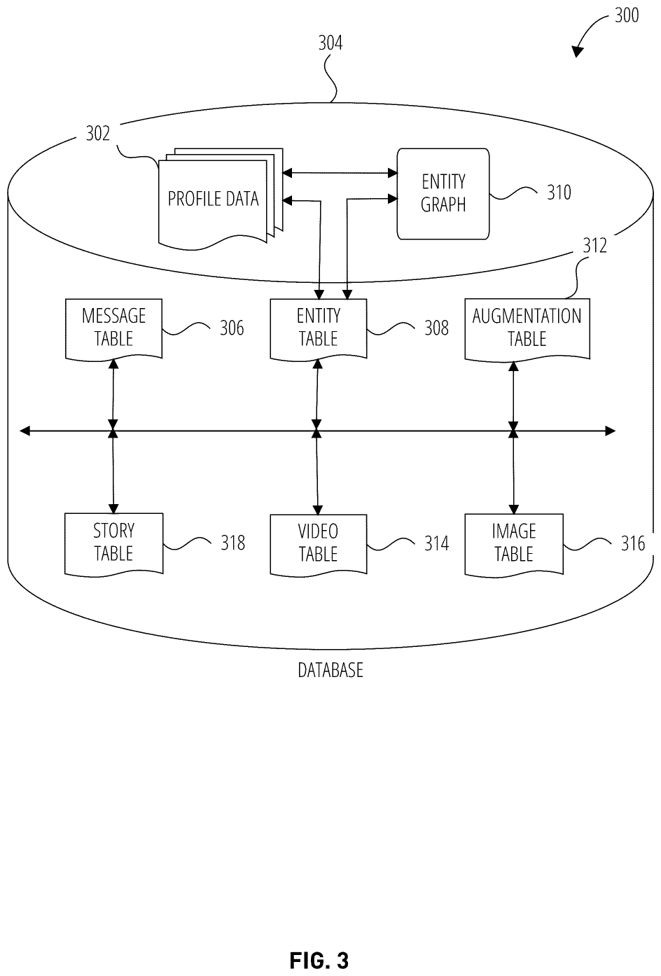

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations).

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a UI by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content (e.g., corresponding to applying “lenses” or augmented reality experiences). An augmented reality content may be a real-time special effect and sound that may be added to an image or a video.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the UI of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a UI of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

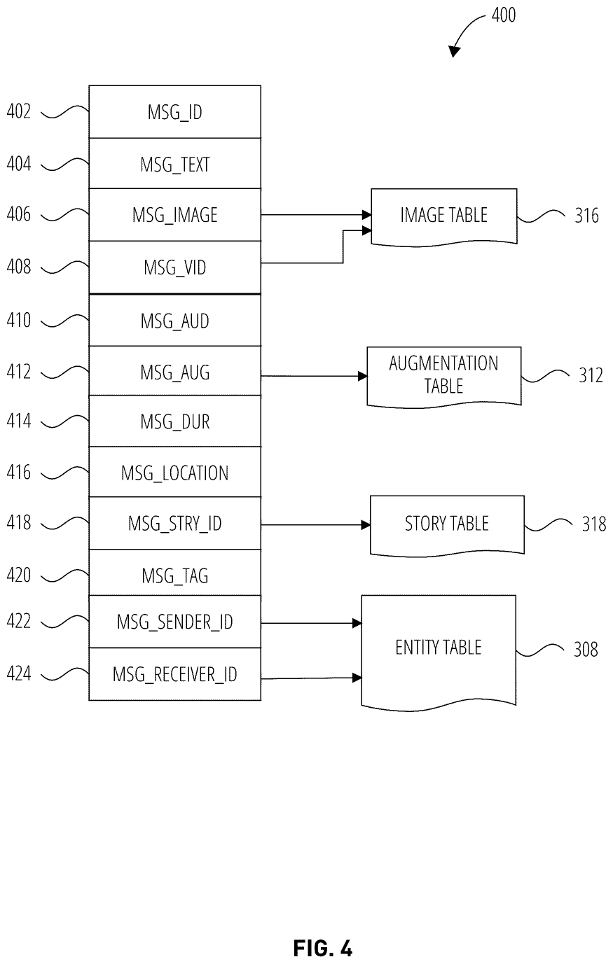

FIG. 4 is a schematic diagram illustrating a structure of a message 400, according to some examples, generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier 402: a unique identifier that identifies the message 400.
Message text payload 404: text, to be generated by a user via a UI of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more content collections (e.g., “stories” identified in the story table 318) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which messaging content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a story table 318, and values stored within the message sender identifier 422 and the message receiver identifier 424 may point to user records stored within an entity table 308.

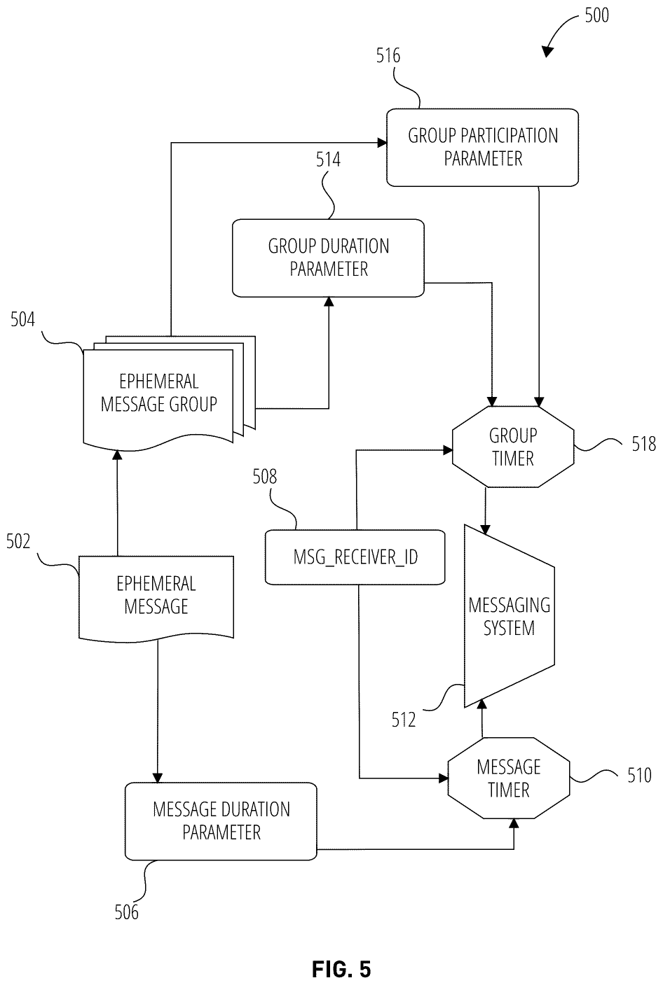

FIG. 5 is a schematic diagram illustrating an access-limiting process 500, in terms of which access to content (e.g., an ephemeral message 502 and associated multimedia payload of data) or a content collection (e.g., an ephemeral message group 504) may be time-limited (e.g., made ephemeral).

An ephemeral message 502 is shown to be associated with a message duration parameter 506, the value of which determines the amount of time that the ephemeral message 502 will be displayed to a receiving user of the ephemeral message 502 by the interaction client 104. In some examples, an ephemeral message 502 is viewable by a receiving user for up to a maximum of 10 seconds, depending on the amount of time that the sending user specifies using the message duration parameter 506.

The message duration parameter 506 and the message receiver identifier 508 are shown to be inputs to a message timer 510, which is responsible for determining the amount of time that the ephemeral message 502 is shown to a particular receiving user identified by the message receiver identifier 508. In particular, the ephemeral message 502 will be shown to the relevant receiving user for a time period determined by the value of the message duration parameter 506. The message timer 510 is shown to provide output to a more generalized messaging system 512, which is responsible for the overall timing of display of content (e.g., an ephemeral message 502) to a receiving user.

The ephemeral message 502 is shown in FIG. 5 to be included within an ephemeral message group 504 (e.g., a collection of messages in a personal story, or an event story). The ephemeral message group 504 has an associated group duration parameter 514, a value of which determines a time duration for which the ephemeral message group 504 is presented and accessible to users of the interaction system 100. The group duration parameter 514, for example, may be the duration of a music concert, where the ephemeral message group 504 is a collection of content pertaining to that concert. Alternatively, a user (either the owning user or a curator user) may specify the value for the group duration parameter 514 when performing the setup and creation of the ephemeral message group 504.

Additionally, each ephemeral message 502 within the ephemeral message group 504 has an associated group participation parameter 516, a value of which determines the duration of time for which the ephemeral message 502 will be accessible within the context of the ephemeral message group 504. Accordingly, a particular ephemeral message group 504 may “expire” and become inaccessible within the context of the ephemeral message group 504 prior to the ephemeral message group 504 itself expiring in terms of the group duration parameter 514. The group duration parameter 514, group participation parameter 516, and message receiver identifier 508 each provide input to a group timer 518, which operationally determines, firstly, whether a particular ephemeral message 502 of the ephemeral message group 504 will be displayed to a particular receiving user and, if so, for how long. Note that the ephemeral message group 504 is also aware of the identity of the particular receiving user as a result of the message receiver identifier 508.

Accordingly, the group timer 518 operationally controls the overall lifespan of an associated ephemeral message group 504 as well as an individual ephemeral message 502 included in the ephemeral message group 504. In some examples, each and every ephemeral message 502 within the ephemeral message group 504 remains viewable and accessible for a time period specified by the group duration parameter 514. In a further example, a certain ephemeral message 502 may expire within the context of ephemeral message group 504 based on a group participation parameter 516. Note that a message duration parameter 506 may still determine the duration of time for which a particular ephemeral message 502 is displayed to a receiving user, even within the context of the ephemeral message group 504. Accordingly, the message duration parameter 506 determines the duration of time that a particular ephemeral message 502 is displayed to a receiving user regardless of whether the receiving user is viewing that ephemeral message 502 inside or outside the context of an ephemeral message group 504.

The messaging system 512 may furthermore operationally remove a particular ephemeral message 502 from the ephemeral message group 504 based on a determination that it has exceeded an associated group participation parameter 516. For example, when a sending user has established a group participation parameter 516 of 24 hours from posting, the messaging system 512 will remove the relevant ephemeral message 502 from the ephemeral message group 504 after the specified 24 hours. The messaging system 512 also operates to remove an ephemeral message group 504 when either the group participation parameter 516 for each and every ephemeral message 502 within the ephemeral message group 504 has expired, or when the ephemeral message group 504 itself has expired in terms of the group duration parameter 514.

In certain use cases, a creator of a particular ephemeral message group 504 may specify an indefinite group duration parameter 514. In this case, the expiration of the group participation parameter 516 for the last remaining ephemeral message 502 within the ephemeral message group 504 will determine when the ephemeral message group 504 itself expires. In this case, a new ephemeral message 502, added to the ephemeral message group 504, with a new group participation parameter 516, effectively extends the life of an ephemeral message group 504 to equal the value of the group participation parameter 516.

Responsive to the messaging system 512 determining that an ephemeral message group 504 has expired (e.g., is no longer accessible), the messaging system 512 communicates with the interaction system 100 (and, for example, specifically the interaction client 104) to cause an indicium (e.g., an icon) associated with the relevant ephemeral message group 504 to no longer be displayed within a UI of the interaction client 104. Similarly, when the messaging system 512 determines that the message duration parameter 506 for a particular ephemeral message 502 has expired, the messaging system 512 causes the interaction client 104 to no longer display an indicium (e.g., an icon or textual identification) associated with the ephemeral message 502.

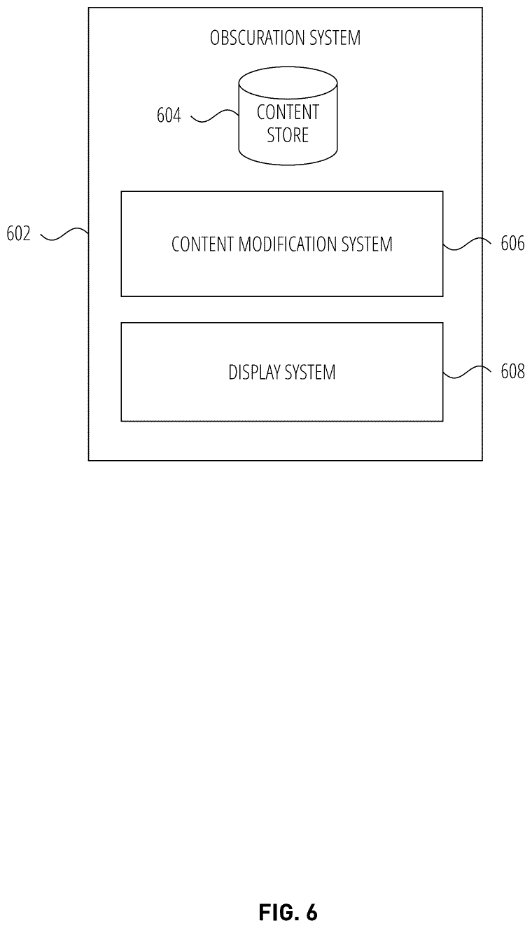

FIG. 6 is a block diagram of the obscuration system 602, according to some embodiments. The obscuration systems 602 is responsible for obscuring visual content from screen capture by a user device. As shown, the obscuration system 602 includes a content store 604, a content modification system 606, and a display system 608. The obscuration system 602 is an example of the obscuration system 218 of FIG. 2.

The content store 604 stores content data and content items to be obscured by the obscuration system 602. The content store 604 also stores any other related content (e.g., modified content items). The content data and content items may be obtained from a user, for example, through the communication system 208. As an example, the content data and/or content item may be included as part of an ephemeral message, such as ephemeral message 502. The content data may include other data to be provided to a user with the intent to obscure screen capture, such as any private or sensitive data.

The content data stored in the content store 604 includes at least a content item, where the content item corresponds to visual content. The content item includes a set of pixels. A color of each pixel is based on a pixel vector of the pixel. When the content item is provided for display, a display illuminates each pixel according to its associated pixel vector.

As referenced herein, ‘pixel’ may refer interchangeably to the smallest addressable element in visual content (e.g., a raster image) or the elements of a physical display. When referring to the latter, they are illuminated as prescribed by the former. According to some embodiments, the obscuration system 602 accesses display information about the user device, including the resolution (i.e., dimensions of pixels) of the physical display. Each physical pixel in the display is illuminated according to the pixels that make up the content item.

The physical pixels in a display can be subdivided into subpixel elements, each associated with a particular color. For example, in some displays, each pixel may contain a red subpixel, a green subpixel, and a blue subpixel (RGB pixel). The actual colors of each subpixel and number of subpixels in each pixel may vary based on the display type.

Each pixel is associated with a pixel vector that indicates how the pixel appears (color, intensity, etc.). Similarly, each subpixel is associated with a subpixel value, where the subpixel value indicates the intensity of the subpixel. Subpixel values are derived based on the pixel's pixel vector. For example, an RGB pixel may have a pixel vector containing three values, where each value is a subpixel value associated with a subpixel.

The content modification system 606 modifies a content item to generate modified content item. The content modification system 606 can access a content item that is stored in the content store 604. The modified content item includes a set of frames, which is generated based on the content item. The type of modification to the content item, including determining the number of frames in the set of frames, can vary in different embodiments. For example, the number of frames in the set of frames may be determined based on the display refresh rate of the user device and/or the processor capability of the user device. The generated modified content item, including the set of frames, can be stored in the content store 604.

According to some embodiments, the content modification system 606 generates a set of frames including at least a first frame and a second frame. The first frame comprises a modified version of the content item and the second frame comprises a solid color. In an example, the first frame contains the content item with increased brightness and the second frame is all black. In another example, the first frame contains the content item with decreased brightness and the second frame is all white. There may be additional frames in the set of frames, for example, a third frame that is the solid color. Generating the first frame may include other visual modifications to the content item, such as altering contrast and/or saturation. The type and degree of modification to the content item to generate the first frame may be based on the original brightness of the content item, the original contrast of the content item, the original saturation of the content item, the ambient brightness of the environment surrounding the user's device, the display refresh rate of the user device, and/or the processor capabilities of the user device.

According to some embodiments, the content modification system 606 generates a set of frames by dividing the set of pixels of the content item into multiple subsets and distributing them among the frames. The set of frames includes at least a first frame and a second frame. The first frame includes a first subset of pixels of the content item and the second frame includes a second subset of pixels of the content item. In some embodiments, the set of frames may include one or more additional frames, which each contain a subset of pixels. The pixels in each subset of pixels may be randomly selected. In some embodiments, the number of pixels in each subset of pixels is based on a predetermined amount of pixels from the content item to be included in each subset. The predetermined amount of pixels may vary by frame or be equal in each frame. The predetermined amount may be based on the number of frames in the set of frames. In an example, the set of frame includes two frames and each frame comprises half of the pixels from the content item based on the predetermined amount. That is, the first frame includes a first half of pixels from the content item and the second frame includes a second half of pixels. In another example, the predetermined amount for each subset for each subset is different, the set of frames includes two frames and the first frame contains one-third of the total number of pixels, and the second frame contains two-thirds of the total number of pixels.

According to some embodiments, the content modification system 606 generates a set of frames by distributing the set of subpixels that make up the content item among the frames. The set of frames includes at least a first frame and a second frame. The first frame has a first subset of subpixel values and the second frame has a second subset of subpixel values. The set of frames may include additional frames, each containing a subset of subpixel values. Each subset of subpixel values may contain subpixel values of multiple different colors. The subpixel values in each subset of subpixel values may be randomly selected. In some embodiments, the number of subpixel values in each subset of subpixel values is a predetermined amount. The predetermined amount of subpixel values may vary by frame or be equal in each frame. The predetermined amount may be based on the number of frames in the set of frames.

The display system 608 provides the modified content item, including the set of frames, for display on a user device. The display system 608 may communicate with other systems on a server and/or connected client devices, such as the user device, the interaction clients 104, and the interaction servers 124. In some embodiments, this may involve sending the modified content item to the user device with instructions for the user device to display the content.

In an example where the set of frames contains two frames, the display system 608 may provide instructions that cause the user device to alternate between displaying the first frame and the second frame. In an example where the set of frames contains n frames, the display system 608 may provide instructions that cause the user device to rotate between displaying the first frame, then the second frame, . . . then the nth frame, then the first frame, and so on.

In some embodiments, the instructions provided by the display system 608 specify the rate at which the user device is to switch between frames. In some embodiments, the display system 608 accesses the display refresh rate and/or the processor capabilities of the user device in order to determine the rate. In an example, the user device has a rapid display refresh rate but slow processor capabilities. Accordingly, the display system 608 may generate instructions for display that cause the dynamic display to update more slowly than the display refresh rate as to not overload the processor capabilities of the user device. In some embodiments, the rate is the display refresh rate of the user device.

In some embodiments, the rate may vary from frame to frame. That is, each frame is displayed for a predetermined duration. In examples with a first frame and a second frame, the first frame is be displayed for a first duration and the second frame is displayed for a second duration. The first duration and the second duration may be identical or may be different. In examples where the first frame is a modified version of the content item and the second frame is a solid color, the second duration may be twice the first duration. That is, the solid color may be displayed for twice as long as the modified content item. As a result, a user is more likely to screen capture the solid color than the modified content item.

In examples where the content item is included as part of content data that is an ephemeral message, the display system 608 provides the modified content item for display on the user device for as long as the ephemeral message lasts. For example, the content data may be ephemeral message 502 with message duration parameter 506. After the ephemeral message expires, the modified content item is no longer provided for display on the user device. The display system 608 may work in conjunction with the ephemeral timer system 220 in the messaging system 210 to present content data that is an ephemeral message.

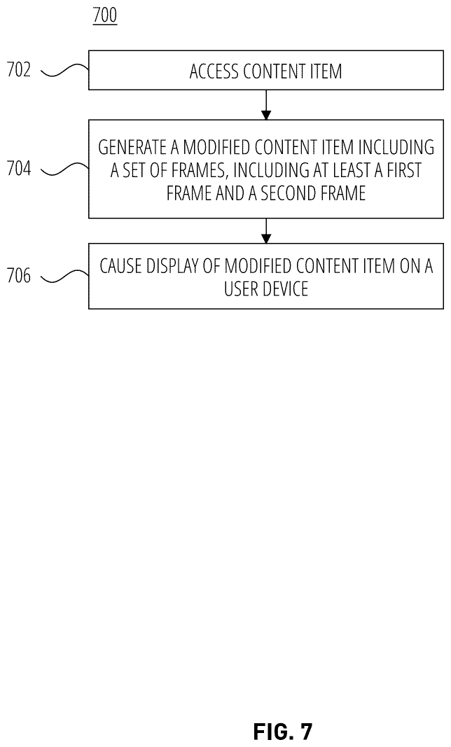

FIG. 7 is a flowchart for a method 700 of obscuring content from screen capture by a user device, according to some embodiments. The method 700 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 700 is performed by functional components of the interaction system 100. While the operations below are described as being performed by a processing device, it shall be appreciated that the operations of the method 700 may not necessarily be performed by the same processing device. Accordingly, any one or more of the operations of the method 700 can be performed by any one or more of the interaction client 104, the interaction servers 124, the communication system 208, or the user device 1106. Similarly, the processing device may be the user device on which the method 700 is obscuring screen capture.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 702, the processing device accesses a content item (e.g., from the content store 604). The content item includes visual content. The content item may be part of content data, which may include additional non-visual content and/or metadata. In some embodiments, the content data is an ephemeral message accessed by the processing device. The content item is made up of pixels, each with an associated pixel vector indicating how the pixel should illuminate. In some embodiments, each pixel vector includes multiple subpixel values, each associated with a type of subpixel (e.g., color).

At operation 704, the processing device generates a modified content item based on the content item. The modified content item includes a set of frames. The processing device modifies the content item to generate the modified content item. In generating the set of frames, the processing devices generates a first frame and a second frame.

The set of frames may include any number of additional frames. Thus, the generating of the modified content may further include determining a number of frames to generate and generating the number of frames. The number of frames can be determined based on the display refresh rate of the user device and/or the processor capabilities of the user device.

At operation 706, the processing device causes a display device of the user device to display the modified content item. In causing the display device to display the modified content item, the processing device causes the user device to alternate between displaying the first frame and the second frame. That is, the user device displays the first frame for a first duration of time and then displays the second frame for a second duration of time, then displays the first frame for a first duration of time, and so on.

The first duration and the second duration are short enough to not be readily perceived by the human eye. For some embodiments, the processing device determines a display refresh rate of the user device and determines the first duration and the second duration based on the display refresh rate. For some embodiments, the processing device determines the processor capabilities of the user device and determines the first duration and the second duration based on the processor capabilities. The first duration and the second duration may be equal to each other or may be different durations.

The display of the modified content item alternates between the first frame and the second frame for as long as the user device is caused to display the content item. For some embodiments, the amount of time the content item is displayed is based on the ephemeral timer system 220 and the content item is only available for display for a time-limited period.

In the embodiments where there are additional frames in the set of frames, the display of the modified content item rotates between displaying each frame in the set of frames. When the final frame in the set of frames is displayed, the display of the modified content item returns to the first frame in the set of frames.

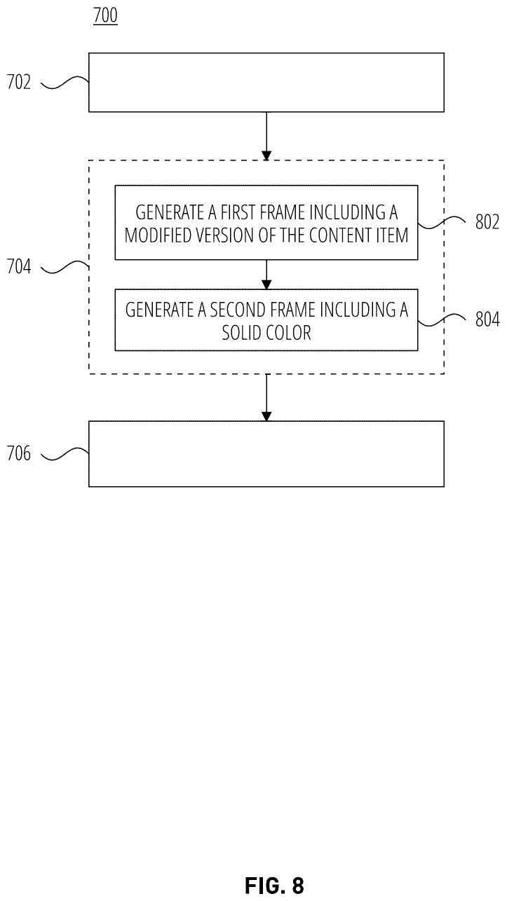

FIG. 8 shows the method 700 may, in some embodiments, further include operation 802 and operation 804. Consistent with these embodiments, the operation 802 and the operation 804 may be performed as part of the operation 704 where the processing device generates modified content item.

At operation 802, the processing device generates a first frame including a modified version of the content item. Consistent with these embodiments, the processing device generates the first frame by adjusting (e.g., increasing or decreasing) the brightness of the content item, adjusting (e.g., increasing or decreasing) the contrast, adjusting (e.g., increasing or decreasing) the saturation, or adjusting any other visual characteristic of the content item. The manner in which the processing device modifies the content item to generate the first frame is based on any one or more of the original brightness of the content item, the original contrast of the content item, the original saturation of the content item, the ambient brightness of the environment surrounding the user device, the processor capabilities of the user device, and/or the display refresh rate of the user device.

At operation 804, the processing device generates a second frame including a solid color. Consistent with these embodiments, the processing device generates the second frame to have the same dimensions as the first frame. The pixels of the second frame all contain the same pixel vector to form a frame of the solid color. The solid color (e.g., the pixel vector) is determined by the processing device based on the modifications made to the content item to generate the first frame. For example, if the first frame is generated by increasing the brightness of the content item, the second frame is generated to be black to counter the increased brightness. As a result, the dynamic display of the set of frames has a perceived brightness that is similar to the original content item. Frames added to the set of frames in addition to the first frame and second frame discussed above may each include the solid color.

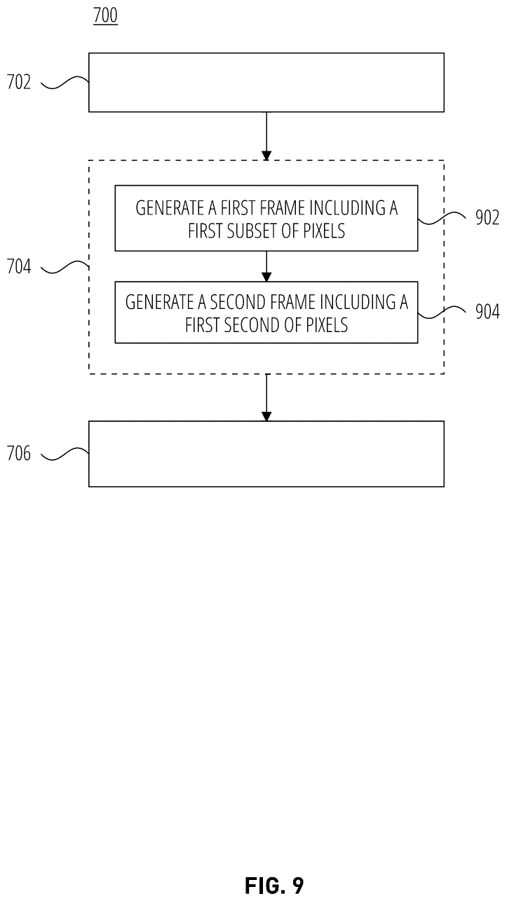

FIG. 9 shows the method 700 may, in some embodiments, further include operation 902 and operation 904. Consistent with these embodiments, the operation 902 and the operation 904 may be performed as part of the operation 704 where the processing device generates modified content item.

Consistent with these embodiments, modifying the content item includes distributing the total set of pixels that make up the content item among the set of frames. At operation 902, the processing device generates a first frame including a first subset of pixels of the content item. At operation 904, the processing device generates a second frame including a second subset of pixels of the content item. The number of pixels in each subset of pixels may be predetermined or random. The number of pixels in each subset of pixels may be the same in each frame or different. The location of the pixels within the content item in each subset of pixels may be ordered or randomized. Consistent with these embodiments, additional frames may be added to the set of frames, and the additional frames each include a subset of pixels.

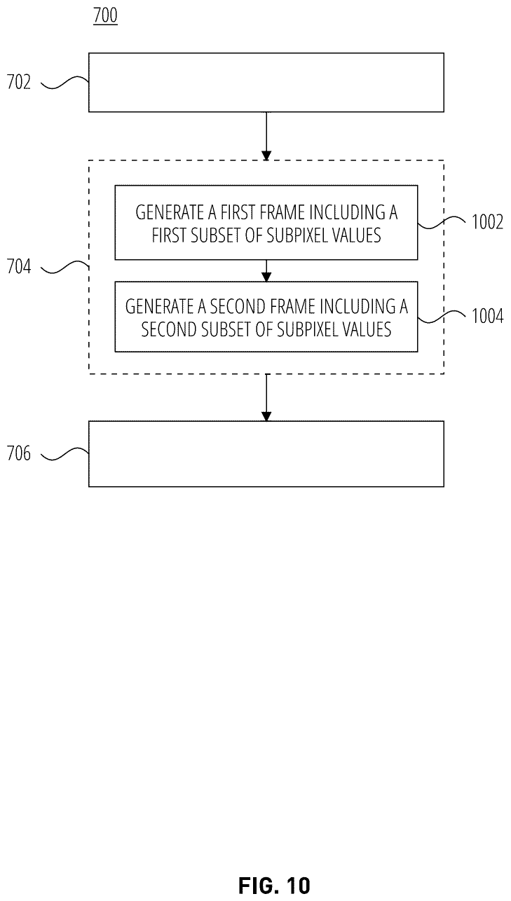

FIG. 10 shows the method 700 may, in some embodiments, further include operation 1002 and operation 1004. Consistent with these embodiments, the operation 1002 and the operation 1004 may be performed as part of the operation 704 where the processing device generates modified content item.

Consistent with these embodiments, modifying the content item includes deriving subpixel values from the pixel vectors of the content item and distributing the total set of subpixel values among the set of frames. At operation 1002, the processing device generates a first frame including a first subset of subpixel values. At operation 1004, the processing device generates a second frame including a second subset of subpixel values. The number of subpixel values in each subset of subpixel values may be predetermined or random. The number of subpixel values in each subset of subpixel values may be the same in each frame or different. The physical locations within a physical display of the subpixels associated with each subset of subpixel values may be ordered or randomized. Consistent with these embodiments, additional frames may be added to the set of frames, and the additional frames each include a subset of subpixel values.

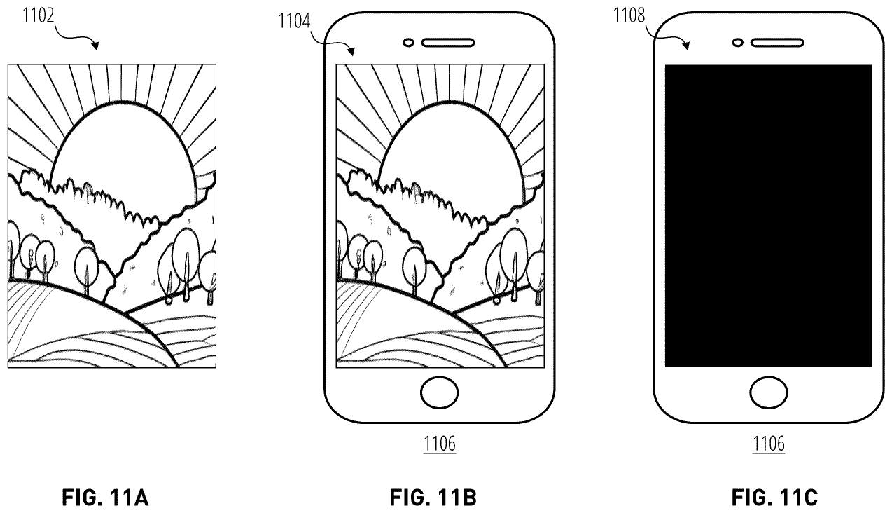

FIG. 11A illustrates an example content item 1102 in accordance with some embodiments. The content item 1102 is an image depicting a landscape captured by a client device in this illustrative example, though the content item 1102 may be any image or any other type of visual content, such as a video or one or more frames thereof. The content item 1102 may be part of content data. In this illustrative example, the content data is included as part of an ephemeral message. The content data may include additional content other than the content item 1102, such as audio, text, and metadata. The content data, including the content item 1102, is stored in the content store 604.

FIG. 11B illustrates an example first frame 1104 being displayed on a user device 1106 in accordance with some embodiments. The content modification system 606 modifies the content item 1102 to generate the first frame 1104. In this illustrative example, the brightness of the content item 1102 was increased to generate the first frame 1104.

The user device 1106 in the illustrative example is a smart phone, though in other examples, the user device 1106 may be a laptop, tablet, smart watch, smart phone of any other type, or any other computerized device with a screen capable of being used by a user. The user device 1106 may be the user system 102, interaction client 104, or any other client device.

The user device 1106 displays the first frame 1104 for a first duration of time. In this illustrative example, the first duration of time is based on the display refresh rate of the user device 1106, though in other examples, the first duration of time may also or alternatively be based on the processor capabilities of the user device 1106. After displaying the first frame 1104 for the first duration of time, the user device 1106 displays a second frame 1108, which is illustrated in FIG. 11C.

FIG. 11C illustrates an example second frame 1108 being displayed on the user device 1106 in accordance with some embodiments. The first frame 1104 and the second frame 1108 collectively form a set of frames. The content modification system 606 modifies the content item 1102 to generate the second frame 1108. In this illustrative example, the second frame 1108 is a solid color, black, though the second frame 1108 may be another solid color. For example, the content modification system 606 may generate a first frame 1104 that has decreased brightness and a second frame that is solid white in color.

The user device 1106 displays the second frame 1108 for a second duration of time. In this illustrative example, the second duration of time is equal to twice the display refresh rate of the user device 1106. In some embodiments, the second duration of time may be based on the display refresh rate and/or the processor capabilities of the user device 1106. In some instances, the first duration of time is equal to the second duration of time.

After displaying the second frame 1108 for the second duration of time, the user device 1106 displays the first frame 1104 for the first duration of time. The user device 1106 continues to alternate between displaying the first frame 1104 for the first duration of time and the second frame 1108 for the second duration of time for as long as the user is viewing the content item. In examples where the content item 1102 is included in an ephemeral message, the user device 1106 displays the content for as long as enabled by the ephemeral timer system 220. For example, if the content item 1102 is part of the ephemeral message 502, the ephemeral message 502 is no longer available after the message duration parameter 506 has passed in time.

Displaying the content item 1102 to the user in a dynamic display as a set of frames, alternating between the first frame 1104 and the second frame 1108, obscures the content item from screen capture. Should the user attempt a screen capture, they are more likely to capture the second frame 1108 which is solid black. In the event the user captures the first frame 1104, the content item 1102 would have increased brightness and would appear differently than the static content item 1102 in FIG. 11A with ordinary brightness.

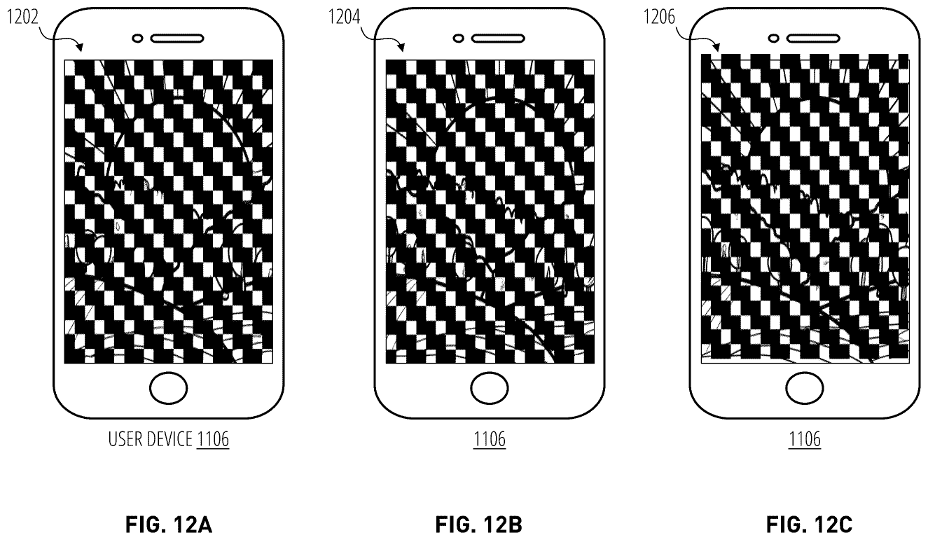

FIG. 12A illustrates an example first frame 1202 displayed on a user device 1106 in accordance with some embodiments. The content item 1102 has been modified by the content modification system 606 to generate the first frame 1104. In this illustrative example, the first frame 1202 contains a first subset of pixels of the content item 1102. The remaining pixels in the first frame 1202 are a solid color, in this case black.

The user device 1106 displays the first frame 1202 for a first duration of time. In this illustrative example, the first duration of time is based on the display refresh rate of the user device 1106, though in other examples the first duration of time may also or alternatively be based on the processor capabilities of the user device 1106. After displaying the first frame 1202 for the first duration of time, the user device 1106 displays a second frame 1204, which is illustrated in FIG. 12B.

FIG. 12B illustrates an example second frame 1204 displayed on a user device 1106 in accordance with some embodiments. The content modification system 606 modifies the content item 1102 to generate the second frame 1204. In this illustrative example, the second frame 1204 contains a second subset of pixels of the content item 1102. The remaining pixels in the second frame 1204 are a solid color, in this case black.

The user device 1106 displays the second frame 1204 for a second duration of time. In this illustrative example, the second duration of time is based on the display refresh rate of the user device 1106, though in other examples the second duration of time may also or alternatively be based on the processor capabilities of the user device 1106. After displaying the second frame 1204 for the second duration of time, the user device 1106 displays a third frame 1206, which is illustrated in FIG. 12C.

FIG. 12C illustrates an example third frame 1206 displayed on a user device 1106 in accordance with some embodiments. The content modification system 606 modifies the content item 1102 to generate the third frame 1206. In this illustrative example, the third frame 1206 contains a third subset of pixels of the content item 1102. The remaining pixels in the third frame 1206 are a solid color, in this case black.

The user device 1106 displays the third frame 1206 for a third duration of time. In this illustrative example, the third duration of time is based on the display refresh rate of the user device 1106, though in other examples the third duration of time may also or alternatively be based on the processor capabilities of the user device 1106. After displaying the third frame 1206 for the first duration of time, the user device 1106 returns to a display of the first frame 1202.

The user device 1106 continues to rotate through displaying the first frame 1202 for the first duration of time, the second frame 1204 for the second duration of time, and the third frame 1206 for the third duration of time for as long as the user is viewing the content item, or, in instances in which the content item is included as part of an ephemeral message, the user device 1106 displays the content for long as enabled by the ephemeral timer system 220.

The first frame 1202, the second frame 1204, and the third frame 1206 collectively form a set of frames. In this example, each subset of pixels in each frame in the set of frames contains one-third the total number of pixels in the content item 1102 based on a predetermined amount of pixels associated with each frame. For other examples, the number of pixels in each subset of pixels may vary from frame to frame, or be randomized. Further, the set of pixels that make up the content item 1102 are distributed among the set of frames. That is, each pixel in the content item 1102 is found in either the first subset of pixels, the second subset of pixels, or the third subset of pixels. Thereby, the dynamic display of the set of frames appears as the complete content item 1102 to the human eye.

The first frame 1202, the second frame 1204, and the third frame 1206 each contain a subset of pixels at predetermined locations within the content item 1102. That is, the subsets of pixels are ordered. In other embodiments, the pixels in each subset of pixels are random. That is, the content modification system 606 randomizes the selection of pixels for each frame. In some such embodiments, the content modification system 606 randomly selects a predetermined amount of pixels to be in each subset of pixels.

For some embodiments, there may be fewer or more frames in the set of frames than illustrated in FIG. 12A, FIG. 12B, and FIG. 12C. The predetermined amount of pixels in each frame may be calculated based on the number of frames in the set of frames. The number of frames in the set of frames may be determined by the obscuration system 602 based on the display refresh rate and/or processor capabilities of the user device 1106. For example, the obscuration system 602 determines the user device 1106 has a high display refresh rate and high processor capabilities and determines the set of frames has five frames total. Consequently, the content modification system 606 determines each frame contains one-fifth the total number of pixels in the content item 1102. Such calculations by the obscuration system 602 are made based on what speed of refreshing frames is undetectable to the human eye.

Displaying the content item 1102 to the user in a dynamic display as a set of frames, rotating through the first frame 1202, the second frame 1204, and the third frame 1206, obscures the content item from screen capture. Should the user take a screen capture, they will only capture one-third of the total pixels that make up the content item 1102. As can be observed from FIG. 12A, FIG. 12B, and FIG. 12C, it is difficult to make out the content item 1102 from one-third of the pixels. As a result, modifying and dynamically displaying the content obscures screen capture.

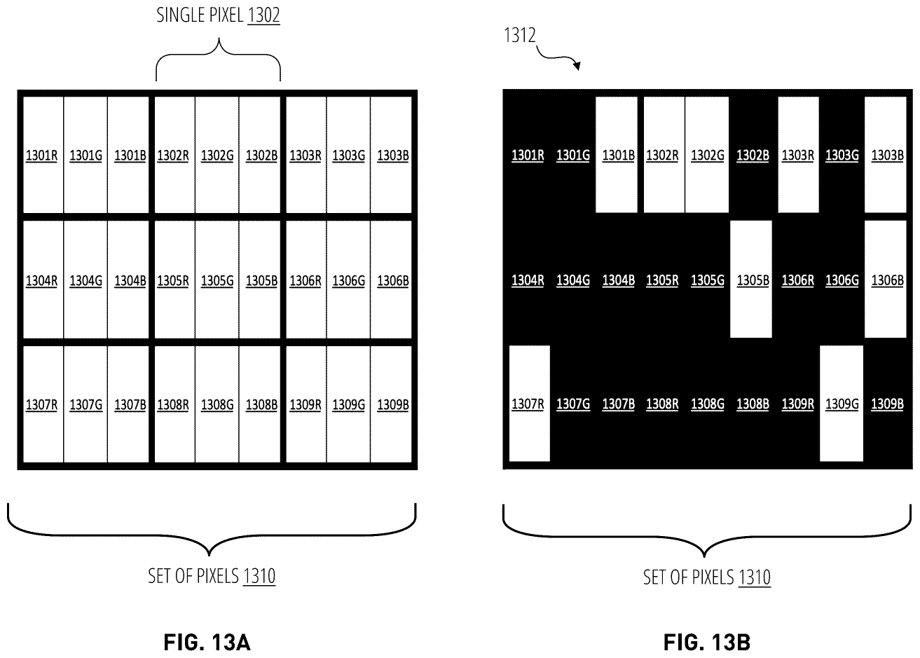

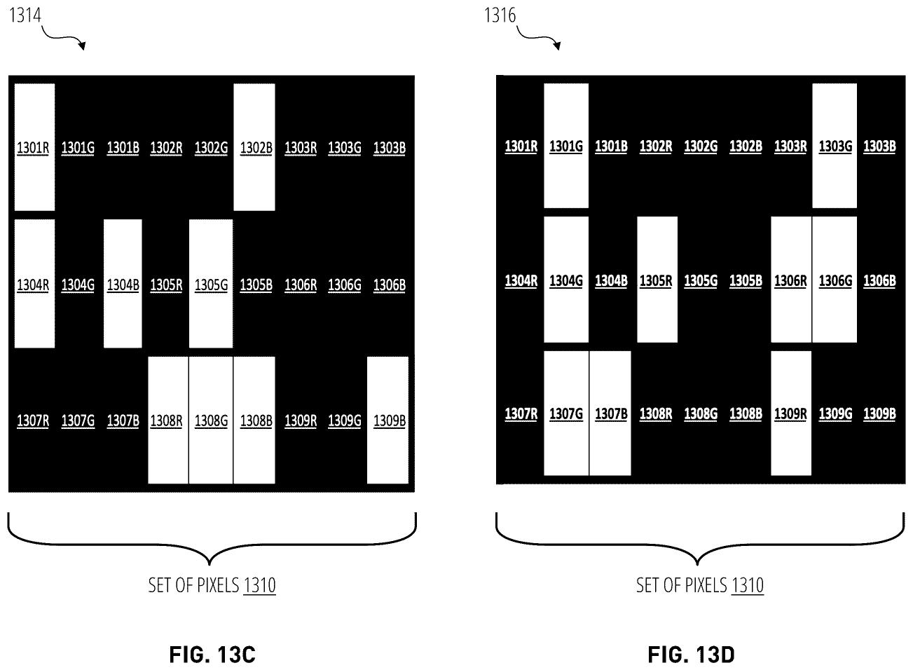

FIG. 13A illustrates a set of pixels 1310 and their subpixels in accordance with some embodiments. Each pixel in the illustrative set of pixels 1310 includes a red subpixel, a green subpixel, and a blue subpixel. For example, single pixel 1302 has a red subpixel 1302R, a green subpixel 1302G, and a blue subpixel 1302B. The set of pixels 1310 may be part or all of a display on a user device, such as user device 1106.

A color displayed by each pixel in the set of pixels 1310 is based on a pixel vector. Each pixel vector can be further subdivided into at least three subpixel values. The subpixel values indicate to the respective subpixels the intensity of the subpixel. For example, the single pixel 1302 may receive a pixel vector containing three subpixel values of (0, 0, 255) indicating the color blue. The red subpixel 1302R and the green subpixel 1302G remain off (i.e., illuminate at values 0) and the blue subpixel 1002B illuminates at maximum intensity (i.e., illuminates at value 255).

FIG. 13B illustrates an example first frame 1312 at the pixel-level in accordance with some embodiments. The content modification system 606 generates the first frame 1312 by modifying the content item 1102. In this example, the first frame 1312 includes a first subset of subpixel values selected from the set of pixel vectors of the content item 1102. In this illustrative example the first subset of subpixel values are associated with the following subpixels: blue subpixel 1301B, red subpixel 1302R, green subpixel 1302G, red subpixel 1303R, blue subpixel 1303B, blue subpixel 1305B, blue subpixel 1306B, red subpixel 1307R, and green subpixel 1309G. The remaining subpixels in the set of pixels 1310 that make up the first frame 1312 are a solid color, in this case black. That is, blue subpixel 1301B is illuminated blue based on the associated subpixel value, while red subpixel 1301R and green subpixel 1301G are black.

The user device displays the first frame 1312 for a first duration of time. In this example, the first duration of time is based on the display refresh rate of the user device, though in other examples the first duration of time may also or alternatively be based on the processor capabilities of the user device. After displaying the first frame 1312 for the first duration of time, the user device displays a second frame 1314, as illustrated in FIG. 13C.

FIG. 13C illustrates an example second frame 1314 at the pixel-level in accordance with some embodiments. The content modification system 606 generates the second frame 1314 by modifying the content item 1102. As shown, the second frame 1314 includes a second subset of subpixel values selected from the set of pixel vectors of the content item 1102. In this example the second subset of subpixel values are associated with the following subpixels: red subpixel 1301R, blue subpixel 1302B, red subpixel 1304R, blue subpixel 1304B, green subpixel 1305G, red subpixel 1308R, green subpixel 1308G, blue subpixel 1308B, and blue subpixel 1309B. The remaining subpixels in the set of pixels 1310 that make up the second frame 1314 are a solid color, in this case black. That is, red subpixel 1301R is illuminated red based on the associated subpixel value, while green subpixel 1301G and blue subpixel 1301B are off.

The user device displays the second frame 1314 for a second duration of time. In this example, the second duration of time is based on the display refresh rate of the user device, though in other examples the second duration of time may also or alternatively be based on the processor capabilities of the user device. After displaying the second frame 1314 for the second duration of time, the user device displays a third frame 1316, as illustrated in FIG. 13D.

FIG. 13D illustrates an example third frame 1316 at the pixel-level in accordance with some embodiments. The content modification system 606 generates the third frame 1316 by modifying the content item 1102. In this example, the third frame 1316 includes a third subset of subpixel values selected from the set of pixel vectors of the content item 1102. In this example the third subset of subpixel values are associated with the following subpixels: green subpixel 1301G, green subpixel 1303G, green subpixel 1304G, red subpixel 1305R, red subpixel 1306R, green subpixel 1306G, green subpixel 1307G, blue subpixel 1307B, red subpixel 1309R. The remaining subpixels in the set of pixels 1310 that make up the third frame 1316 are a solid color, in this case black. That is, green subpixel 1301G is illuminated green based on the associated subpixel value, while red subpixel 1301R and blue subpixel 1301B are off.

The user device displays the third frame 1316 for a third duration of time. In this example, the third duration of time is based on the display refresh rate of the user device, though in other examples the third duration of time may also or alternatively be based on the processor capabilities of the user device. After displaying the third frame 1316 for the third duration of time, the user device displays the first frame 1312.

The first frame 1312, the second frame 1314, and the third frame 1316 collectively form a set of frames. Each subset of subpixel values in each frame in the set of frames contains one-third the total number of subpixels in the set of pixels 1310 in this illustrative example. That is, one-third is a predetermined amount of subpixels in each subset of subpixels. In other examples, the amount of subpixel values in each subset of subpixel values may vary from frame to frame, or be randomized. Further, the set of subpixel values that make up the pixel vectors associated with the set of pixels 1310 are distributed among the set of frames. That is, each subpixel in the set of pixels 1310 is illuminated in either the first frame 1312, the second frame 1314, or the third frame 1316. Thereby, the dynamic display of the set of frames appears as the complete content item 1102 to the human eye.

In some embodiments, the content modification system 606 may identify a first portion of subpixels in the content item corresponding to a first type of subpixel value in pixel vectors (e.g., red subpixels), identify a second portion of subpixels in the content item corresponding to a second type of subpixel value in pixel vectors (e.g., green subpixels), and identify a third portion of pixels in the content item corresponding to a third type of subpixel value in pixel vectors (e.g., blue). That is, the content modification system 606 subdivides the pixel vectors by subpixel value type (e.g., color of the subpixel). The content modification system 606 generates the first subset of subpixel values by selecting a first number of subpixel values from the first portion of subpixel values (e.g., reds), selecting a second number of subpixel values from the second portion of subpixel values (e.g., greens), and selecting a third number of subpixel values from the third portion of subpixel values (e.g., blues). For example, the first subset of subpixel values includes a first number of red subpixel values, a second number of green subpixel values, and a third number of blue subpixel values. In the first frame 1312, there are three red subpixel values, two green subpixel values, and four blue subpixel values. That is, in total, there are nine subpixels illuminated in the first frame 1312.

Similarly, the content modification system 606 generates the second subset of subpixel values by selecting a fourth number of subpixel values from the first portion of subpixel values, selecting a fifth number of subpixel values from the second portion of subpixel values, and selecting a sixth number of subpixel values from the first portion of subpixel values. For example, the first subset of subpixel values includes a fourth number of red subpixel values, a fifth number of green subpixel values, and a sixth number of blue subpixel values. In the second frame 1314, there are three red subpixel values, two green subpixel values, and four blue subpixel values. In total, there are nine subpixels illuminated in the second frame 1314.

The content modification system 606 generates the third subset of subpixel values by selecting a seventh number of subpixel values from the first portion of subpixel values, selecting a eighth number of subpixel values from the second portion of subpixel values, and selecting a ninth number of subpixel values from the first portion of subpixel values. For example, the third subset of subpixel values includes a seventh number of red subpixel values, an eighth number of green subpixel values, and a ninth number of blue subpixel values. In the third frame 1316, there are three red subpixel values, five green subpixel values, and one blue subpixel value. In total, there are nine subpixels illuminated in the third frame 1316.

The first frame 1312, the second frame 1314, and the third frame 1316 each contain a subset of subpixel values at randomized locations within the set of pixels 1310. That is, the subsets of subpixel values are random. In some embodiments, the content modification system 606 randomly selects a random number of subpixel values to be in each subset of subpixel values. In other embodiments, the locations of the subpixels associated with each subset of subpixel values is ordered. That is, the content modification system 606 selects subpixel values for subpixels at predetermined locations within the set of pixels 1310 for each frame, similar to the ordered selection of pixels in FIG. 12A, FIG. 12B, and FIG. 12C.

The predetermined amount of subpixels in each frame, according to some embodiments, is calculated based on the number of frames in the set of frames. The number of frames in the set of frames may be determined by the obscuration system 602 based on the display refresh rate and/or processor capabilities of the user device displaying the set of pixels 1310. In the example of FIG. 13B, FIG. 13C, and FIG. 13D, the obscuration system 602 determines pixels need to be illuminated one-third of the time in order to faithfully reproduce the image for the human eye. Thereby, the obscuration system 602 determines the set of frames has three frames total. Consequently, the content modification system 606 determines each frame contains one-third the total number of subpixels in the set of pixels 1310 that make up the content item 1102. Such calculations by the obscuration system 602 are made based on a speed of refreshing frames that is undetectable to the human eye.

Subdividing the set of pixels 1310 into subsets of subpixel values in each frame enables a more granular level of obfuscation of the content item 1102 from screen capture. Should the user take a screen capture, they will only capture one-third of the total subpixels that make up the content item 1102, creating a screen capture with very altered coloring. The screen capture of any of the first frame 1312, the second frame 1314, or the third frame 1316 would not look like the static content item 1102. As a result, modifying and dynamically displaying the content item 1102 according to this illustrative example and related embodiments obscures screen capture.

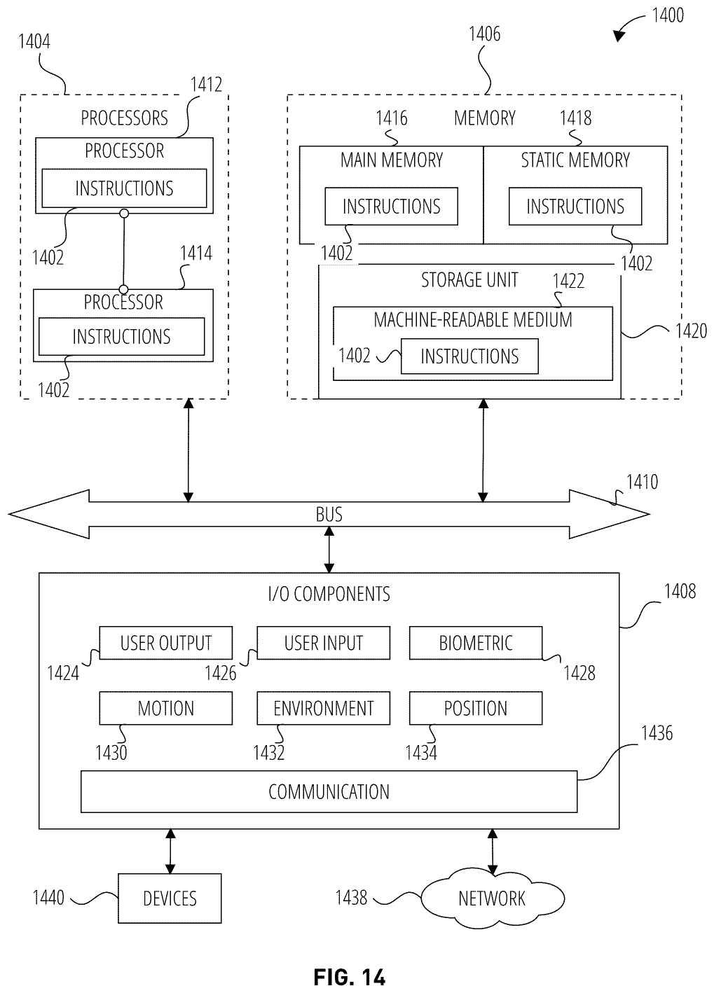

FIG. 14 is a diagrammatic representation of a machine 1400 within which instructions 1402 (e.g., software, a program, an application, an applet, an app, or other executable code) for causing the machine 1400 to perform any one or more of the methodologies discussed herein may be executed. For example, the instructions 1402 may cause the machine 1400 to execute any one or more of the methods described herein. The instructions 1402 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1402, sequentially or otherwise, that specify actions to be taken by the machine 1400. Further, while a single machine 1400 is illustrated, the term “machine” shall also be taken to include a collection of machines that individually or jointly execute the instructions 1402 to perform any one or more of the methodologies discussed herein. The machine 1400, for example, may comprise the user system 102 or any one of multiple server devices forming part of the interaction server system 110. In some examples, the machine 1400 may also comprise both client and server systems, with certain operations of a particular method or algorithm being performed on the server-side and with certain operations of the particular method or algorithm being performed on the client-side.

The machine 1400 may include processors 1404, memory 1406, and input/output I/O components 1408, which may be configured to communicate with each other via a bus 1410. In an example, the processors 1404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1412 and a processor 1414 that execute the instructions 1402. The term “processor” is intended to include multi-core processors that may comprise two or more independent processors (sometimes referred to as “cores”) that may execute instructions contemporaneously. Although FIG. 14 shows multiple processors 1404, the machine 1400 may include a single processor with a single-core, a single processor with multiple cores (e.g., a multi-core processor), multiple processors with a single core, multiple processors with multiples cores, or any combination thereof.

The memory 1406 includes a main memory 1416, a static memory 1418, and a storage unit 1420, both accessible to the processors 1404 via the bus 1410. The main memory 1406, the static memory 1418, and storage unit 1420 store the instructions 1402 embodying any one or more of the methodologies or functions described herein. The instructions 1402 may also reside, completely or partially, within the main memory 1416, within the static memory 1418, within machine-readable medium 1422 within the storage unit 1420, within at least one of the processors 1404 (e.g., within the processor's cache memory), or any suitable combination thereof, during execution thereof by the machine 1400.

The I/O components 1408 may include a wide variety of components to receive input, provide output, produce output, transmit information, exchange information, capture measurements, and so on. The specific I/O components 1408 that are included in a particular machine will depend on the type of machine. For example, portable machines such as mobile phones may include a touch input device or other such input mechanisms, while a headless server machine will likely not include such a touch input device. It will be appreciated that the I/O components 1408 may include many other components that are not shown in FIG. 14. In various examples, the I/O components 1408 may include user output components 1424 and user input components 1426. The user output components 1424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1408 may include biometric components 1428, motion components 1430, environmental components 1432, or position components 1434, among a wide array of other components. For example, the biometric components 1428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1430 include acceleration sensor components (e.g., accelerometer), gravitation sensor components, rotation sensor components (e.g., gyroscope).

The environmental components 1432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1434 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1408 further include communication components 1436 operable to couple the machine 1400 to a network 1438 or devices 1440 via respective coupling or connections. For example, the communication components 1436 may include a network interface component or another suitable device to interface with the network 1438. In further examples, the communication components 1436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1440 may be another machine or any of a wide variety of peripheral devices (e.g., a peripheral device coupled via a USB).

Moreover, the communication components 1436 may detect identifiers or include components operable to detect identifiers. For example, the communication components 1436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1436, such as location via Internet Protocol (IP) geolocation, location via Wi-Fi® signal triangulation, location via detecting an NFC beacon signal that may indicate a particular location, and so forth.

The various memories (e.g., main memory 1416, static memory 1418, and memory of the processors 1404) and storage unit 1420 may store one or more sets of instructions and data structures (e.g., software) embodying or used by any one or more of the methodologies or functions described herein. These instructions (e.g., the instructions 1402), when executed by processors 1404, cause various operations to implement the disclosed examples.

The instructions 1402 may be transmitted or received over the network 1438, using a transmission medium, via a network interface device (e.g., a network interface component included in the communication components 1436) and using any one of several well-known transfer protocols (e.g., hypertext transfer protocol (HTTP)). Similarly, the instructions 1402 may be transmitted or received using a transmission medium via a coupling (e.g., a peer-to-peer coupling) to the devices 1440.

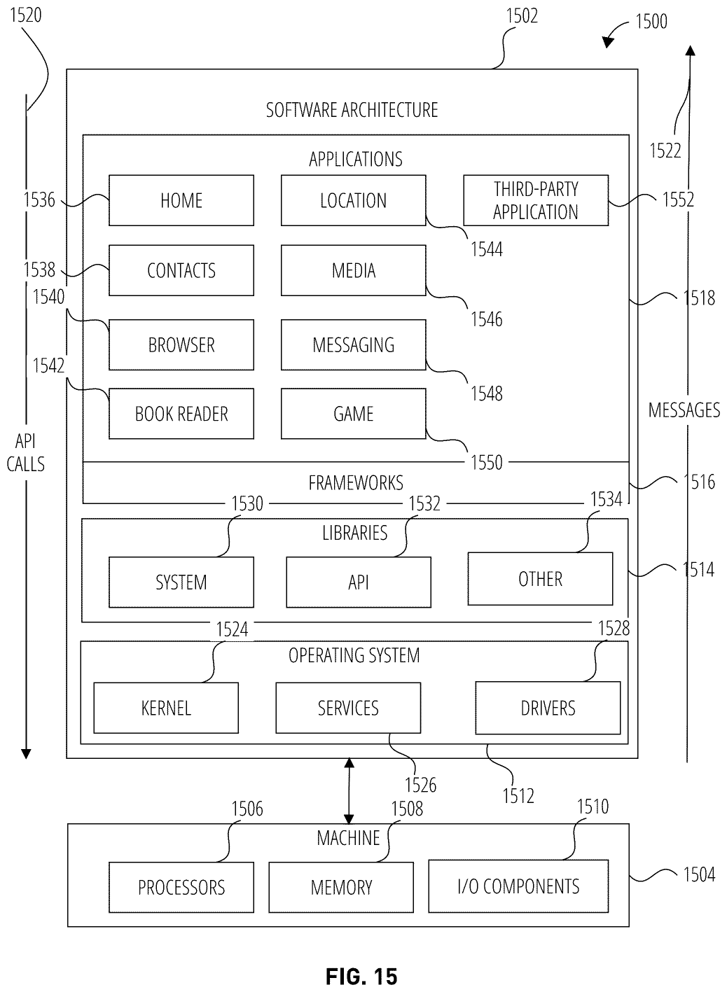

FIG. 15 is a block diagram 1500 illustrating a software architecture 1502, which can be installed on any one or more of the devices described herein. The software architecture 1502 is supported by hardware such as a machine 1504 that includes processors 1506, memory 1508, and I/O components 1510. In this example, the software architecture 1502 can be conceptualized as a stack of layers, where each layer provides a particular functionality. The software architecture 1502 includes layers such as an operating system 1512, libraries 1514, frameworks 1516, and applications 1518. Operationally, the applications 1518 invoke API calls 1520 through the software stack and receive messages 1522 in response to the API calls 1520.

The operating system 1512 manages hardware resources and provides common services. The operating system 1512 includes, for example, a kernel 1524, services 1526, and drivers 1528. The kernel 1524 acts as an abstraction layer between the hardware and the other software layers. For example, the kernel 1524 provides memory management, processor management (e.g., scheduling), component management, networking, and security settings, among other functionalities. The services 1526 can provide other common services for the other software layers. The drivers 1528 are responsible for controlling or interfacing with the underlying hardware. For instance, the drivers 1528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1514 provide a common low-level infrastructure used by the applications 1518. The libraries 1514 can include system libraries 1530 (e.g., C standard library) that provide functions such as memory allocation functions, string manipulation functions, mathematic functions, and the like. In addition, the libraries 1514 can include API libraries 1532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1514 can also include a wide variety of other libraries 1534 to provide many other APIs to the applications 1518.

The frameworks 1516 provide a common high-level infrastructure that is used by the applications 1518. For example, the frameworks 1516 provide various graphical user interface (GUI) functions, high-level resource management, and high-level location services. The frameworks 1516 can provide a broad spectrum of other APIs that can be used by the applications 1518, some of which may be specific to a particular operating system or platform.

In an example, the applications 1518 may include a home application 1536, a contacts application 1538, a browser application 1540, a book reader application 1542, a location application 1544, a media application 1546, a messaging application 1548, a game application 1550, and a broad assortment of other applications such as a third-party application 1552. The applications 1518 are programs that execute functions defined in the programs. Various programming languages can be employed to create one or more of the applications 1518, structured in a variety of manners, such as object-oriented programming languages (e.g., Objective-C, Java, or C++) or procedural programming languages (e.g., C or assembly language). In a specific example, the third-party application 1552 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1552 can invoke the API calls 1520 provided by the operating system 1512 to facilitate functionalities described herein.

The embodiments presented herein provide systems and methods to improve obscuring content from screen capture. The embodiments presented herein enable obscuration of screen capture without relying on an underlying operating system to prevent screen capture. Further, the embodiments of content modification and dynamic display presented herein obscure screen capture while causing the content to appear static to human eye. The embodiments presented herein are useful in a number of use cases, including but not limited to ephemeral messaging and UIs with sensitive content.

As used herein, the term “includes” followed by one or more elements does not exclude the presence of one or more additional elements. The term “or” should be construed as a non-exclusive “or” (e.g., “A or B” may refer to “A,” “B,” or “A and B”) rather than an exclusive “or.” The articles “a” or “an” refer to one or more instances of the following element unless a single instance is clearly specified.

The drawings and written description describe example embodiments of the present disclosure and should not be construed as enumerating essential features of the present disclosure. The scope of the invention should be construed from any claims issuing in a patent containing this description.

“Augmentation” refers to annotating or otherwise modifying or editing content.

“Brightness” refers to the intensity of pixels, and subpixels as applicable. Brightness can be decreased by decreasing the intensity of the pixels. Brightness can be increased by increasing the intensity of the pixels.

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Content data” refers to any content a user may send or receive via a user device. For example, content data may be image data, video data, audio data, text data, metadata, one or more media overlays, or any other content users may send or receive via a user device, or any combination thereof. In one example, content data may be a static image with text and music overlaid. In another example, content data is an ephemeral message. Content data may be or otherwise include visual content, such as a content item.

“Content item” refers to a visual portion of the content data that is to be obscured from screen capture. A content item may be image data, video data, text, a media overlay, or any other visual content. In the previous example wherein the content data is a static image with text and music overlaid, the static image with the text is the content item.

“Display refresh rate” refers to the frequency at which a display updates the visual content being displayed. Display refresh rate may be calculated by the number of times per second the display updates and be presented in Hz. Many conventional displays have a display refresh rate of 60 Hz, however displays may have a display refresh rate that is faster or slower. A faster display refresh rate enables a user to perceive a video or other updating visual content more smoothly.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Frame” refers to static visual data for display. For example, a video may be described as a sequence of frames. The visual data in a frame may have been modified from its original form. A frame can be displayed on a user device.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Media overlay” refers to text or image data that can be overlaid on top of a photograph taken by the or a video stream. In some examples, the media overlay may be a location overlay (e.g., Venice beach), a name of a live event, or a name of a merchant overlay (e.g., Beach Coffee House).

“Non-transitory computer-readable storage medium” refers, for example, to a tangible medium that is capable of storing, encoding, or carrying the instructions for execution by a machine.

“Pixel” refers to a picture element in digital visual content. That is, visual content is made up of elemental pixels. A “pixel” may also refer to the physical display elements of a display device. A pixel can present color based on an associated pixel vector. In some instances, the physical pixel contains subpixel elements capable of displaying individual colors. When visual content is provided for display, a display illuminates each pixel according to the pixel vector data associated with the pixel. If the pixel has subpixels, then each subpixel is illuminated according to the intensity of the pixel vector data associated with each subpixel element.

“Pixel vector” refers to data describing how bright that pixel is, and/or what color it should be. While the term used herein includes ‘vector,’ each pixel vector may be a vector, scalar, of bit-wise value. For example, in a binary image, each pixel has a one-bit pixel vector indicating whether the pixel is on or off. In a greyscale image, each pixel may have a eight-bit pixel vector giving a range of possible greyscale values from 0 to 255. In a color image, each physical pixel may have subpixels and the pixel vector may be represented as one subpixel value for each subpixel. In one example, the pixels have red, green, and blue (RGB) subpixels each associated with a subpixel value that is an eight-bit value from 0 to 255 indicating subpixel color intensity. In such an example, the pixel vector would be a vector of three values, one subpixel value for each subpixel.

“Set of frames” refers to two or more frames. A set of frames can be displayed on a user device. A set of frames may be associated with an ephemeral message such that the set of frames are only available for display for a time-limited duration. A set of frames may be associated with a particular ordering of frames for display.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“Solid color” refers to a uniform color. For example, the solid color may be black. The solid color may be generated by pixel vectors of a uniform value. In embodiments wherein subpixel values are used, the solid color may be generated by subpixel values of a uniform value, or uniform values based on subpixel type. For example, a frame with a solid color of blue may be achieved by generating a first uniform subpixel value of 255 for all blue subpixels and generating a second uniform subpixel value of 0 for all red subpixels and all green subpixels.

“Subpixel” refers to a subdivision of a display device pixel associated with a particular color. In such instances, the pixel contains subpixel elements capable of displaying individual colors at varying intensity. For example, in many color displays, a pixel contains a red subpixel, a green subpixel, and a blue subpixel. In another example, a pixel may contain a cyan subpixel, a magenta subpixel, a yellow subpixel and a black subpixel. The actual colors of the subpixels and number of subpixels may vary based on the display device type.

“Subpixel value” refers to data describing how bright the associated subpixel is. In embodiments where pixel vectors are represented by vectors, each value within the pixel vector is a subpixel value. Each subpixel value is associated with a particular subpixel element, which is in turn associated with a particular color.

“User device” refers, for example, to a device accessed, controlled or owned by a user and with which the user interacts perform an action, or an interaction with other users or computer systems. A user device may be a phone, a smart watch, a tablet, a laptop, or any other computing device capable of sending and/or receiving content.

“Visual content” refers to digital content that can be displayed. Visual content may be an image, a video, text, a media overlay, or any other content that can be rendered on a display.

What is claimed is:

1. A system comprising:
at least one hardware processor; and
at least one memory storing instructions which, when executed by the at least one hardware processor, cause the at least one hardware processor to perform operations comprising:
accessing a content item;
generating a modified content item comprising a set of frames based on the content item, the set of frames comprising:
a first frame comprising a modified version of the content item, and
a second frame comprising a solid color; and
causing display of the modified content item by a user device, the causing of the display comprising causing the user device to alternate between displaying the first frame and the second frame.

2. The system of claim 1, further comprising:
determining a display refresh rate of the user device;
determining a first duration for displaying the first frame based on the display refresh rate; and
determining a second duration for displaying the second frame based on the display refresh rate, wherein the user device displays the first frame for the first duration and displays the second frame for the second duration.

3. The system of claim 1, wherein the set of frames further comprises a number of additional frames comprising the solid color, wherein generating the modified content item further comprises determining the number of additional frames.

4. The system of claim 3, further comprising determining a display refresh rate of the user device, wherein the determining of the number of additional frames is based on the display refresh rate of the user device.

5. The system of claim 3, further comprising determining processor capability of the user device, wherein the determining of the number of additional frames is based on the processor capability of the user device.

6. The system of claim 1, wherein the generating the modified content item further comprises:
modifying the content item to generate the first frame; and
generating the second frame comprising the solid color.

7. The system of claim 6, wherein modifying the content item comprises modifying a brightness of the content item.

8. The system of claim 7, wherein the modifying of the brightness is based on at least one of: a brightness of the content item, a contrast of the content item, and an ambient brightness of a surrounding environment of the user device.

9. A method comprising:
accessing a content item;
generating a modified content item comprising a set of frames based on the content item, the set of frames comprising:
a first frame comprising a modified version of the content item, and
a second frame comprising a solid color; and
causing display of the modified content item by a user device, the causing of the display comprising causing the user device to alternate between displaying the first frame and the second frame.

10. The method of claim 9, further comprising:
determining a display refresh rate of the user device;
determining a first duration for displaying the first frame based on the display refresh rate; and
determining a second duration for displaying the second frame based on the display refresh rate, wherein the user device displays the first frame for the first duration and displays the second frame for the second duration.

11. The method of claim 9, wherein the set of frames further comprises a number of additional frames comprising the solid color, wherein generating the modified content item further comprises determining the number of additional frames.

12. The method of claim 11, further comprising determining a display refresh rate of the user device, wherein the determining of the number of additional frames is based on the display refresh rate of the user device.

13. The method of claim 11, further comprising determining processor capability of the user device, wherein the determining of the number of additional frames is based on the processor capability of the user device.

14. The method of claim 9, wherein the generating the modified content item further comprises:
modifying the content item to generate the first frame; and
generating the second frame comprising the solid color.

15. The method of claim 14, wherein modifying the content item comprises modifying a brightness of the content item.

16. The method of claim 15, wherein the modifying of the brightness is based on at least one of: a brightness of the content item, a contrast of the content item, and an ambient brightness of a surrounding environment of the user device.

17. A machine-readable medium storing instructions which, when executed by one or more processors of a machine, cause the machine to perform operations comprising:
access a content item;
generate a modified content item comprising a set of frames based on the content item, the set of frames comprising:
a first frame comprising a modified version of the content item, and
a second frame comprising a solid color; and
cause display of the modified content item by a user device, the causing of the display comprising causing the user device to alternate between displaying the first frame and the second frame.

18. The machine-readable medium of claim 17, wherein the operations performed further comprise:
determining a display refresh rate of the user device;
determining a first duration for displaying the first frame based on the display refresh rate; and
determining a second duration for displaying the second frame based on the display refresh rate, wherein the user device displays the first frame for the first duration and displays the second frame for the second duration.

19. The machine-readable medium of claim 17, wherein the set of frames further comprises a number of additional frames comprising the solid color, wherein generating the modified content item further comprises determining the number of additional frames.

20. The machine-readable medium of claim 17, wherein the operations performed further comprise:
modifying the content item to generate the first frame; and
generating the second frame comprising the solid color.
